(19) United States
(12) Patent Application Publication
(10) Pub. No.: US 2022/0187806 A1
(43) Pub. Date: Jun. 16, 2022

(54) SAFETY SYSTEM AND METHOD USING A SAFETY SYSTEM

(71) Applicant: SICK AG, Waldkirch (DE)

(72) Inventors: Markus HAMMES, Waldkirch (DE); Patrik FETH, Waldkirch (DE); Magnus ALBERT, Waldkirch (DE); Andreas SIXT, Waldkirch (DE); Tobias HOFMANN, Waldkirch (DE); Eduard MOSGALEWSKY, Waldkirch (DE); Dominic RUH, Waldkirch (DE); Matthias NEUDORF, Waldkirch (DE); Lasse DAU, Waldkirch (DE); Jan SCHLEMMER, Waldkirch (DE); Mathias AMS, Waldkirch (DE); Hagen FETH, Waldkirch (DE); Holger WAIBEL, Waldkirch (DE)

(21) Appl. No.: 17/552,082

(22) Filed: Dec. 15, 2021

(30) Foreign Application Priority Data
Dec. 16, 2020 (DE) 102020133789.2

(51) Int. Cl. G05B 19/418; G01S 5/02

(52) U.S. Cl. CPC G05B 19/41865; G05B 19/41835; G01S 5/0289; G05B 19/41815

(57) ABSTRACT

A method and a safety system for localizing at least two objects with varying locations, having at least one control and evaluation unit, having at least one radio location system, wherein the radio location system has at least three arranged radio stations, wherein at least one respective radio transponder is arranged at the objects, wherein first objects are persons and second objects are mobile objects, wherein the radio transponders have identification, wherein a respective radio transponder is at least associated with either a respective person or a mobile object, whereby the control and evaluation unit is configured to distinguish the persons and mobile objects, and wherein the control and evaluation unit is configured to associate a risk classification with each person at least in dependence on the position of the person with respect to at least one mobile object.

The present invention relates to a safety system for localizing at least two objects with variable locations and to a method having a safety system for localizing at least two objects with variable locations.

It is the current practice in industrial safety engineering to manage hazards locally at the hazard site in that an approach or a presence of a person is detected and a machine or travel movement is stopped or the movement is slowed down in a safety related manner.

The prior art only describes local safety concepts.

It is an object of the invention to provide a safety system that does not only provide a local securing option. It should be made possible that all the persons and mobile objects or mobile vehicles, production routines and/or logistic routines are controllable on the basis of position information that is present such that a residual risk for all involved persons can be tolerated and a productivity of a plant and automation routines are optimum.

The object is satisfied by a safety system for localizing at least two objects with varying locations, having at least one control and evaluation unit, having at least one radio location system, wherein the radio location system has at least three arranged radio stations, wherein at least one respective radio transponder is arranged at the objects, wherein position data of the radio transponder and thus position data of the objects can be determined by means of the radio location system, wherein the position data can be transmitted from the radio station of the radio location system to the control and evaluation unit and/or the position data can be transmitted from the radio transponder to the control and evaluation unit, wherein the control and evaluation unit is configured to cyclically detect the position data of the radio transponders, wherein the radio transponders have identification, wherein a respective radio transponder is associated with a respective object, whereby the control and evaluation unit is configured to distinguish the objects, and wherein the control and evaluation unit is configured to associate a risk classification with each object at least in dependence on the position of the object with respect to another object.

The object is furthermore satisfied by a method having a safety system for localizing at least two objects with varying locations, having at least one control and evaluation unit, having at least one radio location system, wherein the radio location system has at least three arranged radio stations, wherein at least one respective radio transponder is arranged at the objects, wherein position data of the radio transponders and thus position data of the objects are determined by means of the radio location system, wherein the position data are transmitted from the radio station of the radio location system to the control and evaluation unit and/or the position data are transmitted from the radio transponder to the control and evaluation unit, wherein the control and evaluation unit is configured to cyclically detect the position data of the radio transponders, wherein the radio transponders have identification, wherein a respective radio transponder is associated with a respective object, whereby the control and evaluation unit is configured to distinguish the objects, and wherein the control and evaluation unit is configured to associate a risk classification with each object at least in dependence on the position of the object with respect to another object.

The risk classification specifies how great the danger of an object is. The risk classification in particular specifies how great the danger of an object is due to a hazard site at the time t. The hazard site can here be formed by a different object. The risk classification is dependent, for example, on the spacing between the objects and/or on the speeds of the objects or on the approach speed between the objects.

The invention allows a reducing influence to be exerted on the arising of risks in a very forward-looking and early manner with the aid of strategic risk reduction and an avoidance of risks without the productivity losses of known situative risk reduction strategies.

In accordance with the invention, a securing is possible over larger zones, that is, for example, of a large number of work stations, of a large number of robots, or, for example, even of whole production facilities, since not only a local presence or approach of objects is detected, but rather a position of a large number of objects active in an environment or zone can be detected and can be continuously tracked.

This has the advantage that impending hazards can be discovered very much earlier since the control and evaluation unit or the safety system is simultaneously aware of the positions of a large number of objects and likewise knows their cyclic time progression. Measures to reduce risk that intervene a great deal less invasively in the automation routines and that interfere less with the productivity can thereby be carried out by the safety system.

The invention provides position data that can be used in a technical safety manner. This means that the position data of all the objects thus acquired can be used as the basis for a comprehensive, forward-looking, and productivity optimizing securing concept.

The position tracking takes place by means of radio location. The objects are provided with radio transponders via which a localization signal is regularly transmitted to the fixed position radio stations and a position or real time position of the respective object is generated or formed in the control and evaluation unit or in a central control.

In accordance with the invention, the position information of a large number or of all of the objects or mobile participants is available in real time in an industrial work environment.

The previously customary strategy in accordance with the prior art, according to which e.g. a machine is shut down or slowed down on the presence of a person in a hazard zone, can admittedly also be provided in accordance with the invention, but it is also possible to avoid a shutting down or a direct slowing down with the present invention since more information on the total situation and on the positions of the objects is present.

The localization of the radio transponders takes place by time of flight measurements of radio signals that are cyclically exchanged between the radio transponders and a plurality of fixed position radio stations. This triangulation works very well when the signals are transmitted at a sufficient signal strength and on a straight or direct propagation path.

In accordance with a first alternative of the invention, the signals of a radio transponder are received by a plurality of fixed position radio stations or anchor stations and the basis for the localization is created via a time of flight measurement, e.g. the time of arrival (TOA) or e.g. the time difference of arrival (TDOA). The calculation or estimation of the position of a radio transponder then takes place on the control and evaluation unit, for example an RTLS (real time location system) server that is connected to all the radio stations or anchor stations via a wireless or wired data link. This mode of localization is called an RTLS (real time location system) mode.

Alternatively, the position information can, however, also be determined on each radio transponder. In this case, the safety system works in a comparable manner to the GPS navigation system. Each radio transponder receives the signals of the radio stations or anchor stations that are transmitted in a fixed time relationship with one another. A position estimate of the radio transponder can also be carried out here via the different time of flight measurements and the knowledge of the radio station positions or anchor positions. The radio transponder itself calculates its position and can transmit it to the RTLS server as required with the aid of the UWB signal or of other wireless data links.

The position determination in the GPS mode is independent of the position determination in the RTLS mode in different respects:
The calculation does not, for example, take place on a central server, but locally on a radio transponder.
The basis for the position calculation is formed by the determined times of flight of the signals of the fixed position radio stations. Unlike this, the signals of the radio transponders serve for the time of flight calculation in the RTLS mode.
The decision on which subset of the radio station signals present are used for the position calculation is made by the radio transponder on the basis of the determined signal quality and the relative radio station positions. A subset of the transmission signals present is thus used. Conversely, in the RTLS mode, use is made of a subset of the signals received at the different radio stations.

This independence of the position determination can now be used to check the localization. If both modes are operated in parallel, i.e. position data are determined both in the RTLS mode and in the GPS mode, a diverse and redundant comparison can then take place for verification in this manner. The requirement is the merging of both pieces of position information on the control and evaluation unit.

The invention makes possible a strategic risk reduction approach that differs from the known situative risk reduction approach at least in that information is used for the situation evaluation that is determined from a substantially larger spatial zone, for example in the best case the total plant being observed.

Due to the greater range of the input information and the associated greater forewarning time up to the manifestation of a risk, more far-reaching predictions on the expected development of events can take place and possible hazards can be identified considerably earlier in comparison with known environmental sensors that are only locally restricted.

In accordance with the invention, measures for risk reduction are possible that enable an escalating sequence of measures that develop their effectiveness better due to a longer lead time and that also include the effect on the behavior of the persons involved.

In accordance with the invention, an optimization of a total plant or of part zones takes place while taking account of a constraint of a tolerable residual risk as a criterion for a decision.

The risk reduction used here preferably uses the position information of all the objects and, for example, associated accuracy information as the input information.

In a further development of the invention, first objects are mobile objects and second objects are mobile objects, wherein the radio transponders have identification, wherein a respective radio transponder is associated with a mobile object, whereby the control and evaluation unit is configured to distinguish the mobile objects, and wherein the control and evaluation unit is configured to associate a risk classification with each mobile object at least in dependence on the position of one mobile object with respect to at least one other mobile object.

The mobile object or a movable machine or mobile machine can, for example, be a guideless vehicle, a driverless vehicle, an autonomous vehicle, an automated guided vehicle (AGV), an autonomous mobile robot (AMR), an industrial mobile robot (IMR), or a robot having movable robot arms. The mobile machine thus has a drive and can be moved in different directions.

In an alternative further development of the invention, first objects are persons and second objects are mobile objects, wherein the radio transponders have identification, wherein a respective radio transponder is associated with at least one person and a respective radio transponder is associated with at least one mobile object, whereby the control and evaluation unit is configured to distinguish the persons and mobile objects, and wherein the control and evaluation unit is configured to associate a risk classification with each person at least in dependence on the position of a person with respect to at least one mobile object.

In accordance with the further development, a securing is possible over larger zones, for example, of whole production facilities, since not only a local presence or approach of persons is detected, but rather a position of a large number of persons and mobile objects or mobile machines active in an environment or zone can be detected and can be continuously tracked.

The further development provides position data that can be used in a technical safety manner. This means that the position data of all persons and mobile hazard sites thus acquired can be used as the basis for a comprehensive, forward-looking, and productivity optimizing securing concept.

The person can, for example, be an operator or a service engineer. The radio transponders are arranged at the clothing or on the equipment of the person, for example. It can here, for example, be a vest to which the radio transponders are firmly fixed. The radio transponders are arranged, for example, at the shoulders and in the chest and back areas. The radio transponders can, however, also be arranged at different locations on the person. Two radio transponders are, for example, arranged at the shoulders of a vest of a person.

In a further development of the invention, at least one fixed position machine of a plant having a hazard site of the machine is present, with the position of the fixed position hazard site being known to the control and evaluation unit.

In accordance with the further development, a securing is possible over larger zones, that is, for example, of a large number of workstations, of a large number of robots, or, for example, even of whole production facilities.

In accordance with the further development, information on the operating environment such as the knowledge of accessible zones, for example travel paths, and the positions of the hazard sites of the machines are taken into account.

The fixed position machines can, for example, themselves have a radio transponder, whereby the position of the machine is known due to the arranged radio transponder. An accuracy and function of the radio location system can thereby be checked, for example, independently of the objects with varying locations, against an expectation, namely the fixed position radio transponders.

In accordance with the further development, the control and evaluation unit is configured to associate a risk classification with each person at least in dependence on the position of the person with respect to the fixed position machine having the hazard site.

In a further development of the invention, the control and evaluation unit is configured to respectively determine a position of the radio transponders at different times and to determine a speed, an acceleration, a direction of movement, and/or at least one path (trajectory) of the radio transponders therefrom.

In accordance with the further development of the invention, the speeds and directions of movement of all the persons and mobile objects are preferably taken into account.

The position information serve for the calculation of probable movement sequences or trajectories of all the objects, that is the persons or mobile objects.

A family of movement sequences is determined for each person and for each mobile object with the aid of position information and is provided with a degree of probability, for example. The degree of probability is here estimated, for example, on the basis of the distance covered and/or on the direction of movement. Short direct paths are thus, for example, more probable than long indirect paths. The degree of probability can furthermore be estimated on the basis of a known history of routes of the objects. Paths that were used often in the past, for example, are thus more probable than new routes. The degree of probability can furthermore be estimated on the basis of known problems. A disturbed possible route will thus more probably be avoided than a non-disturbed route.

The most probable path, route, or trajectory is selected from a family of possible trajectories and the probabilities associated with them for every person and for every mobile object or for every vehicle.

A trajectory selected for each of N persons has a time-dependent risk classification assigned it for each of M hazard sites that takes account of the spacing or the time-dependent spacing from hazard sites and optionally from details of the automation routines. In the simplest case, the risk can be determined binarily with an approach threshold to a hazard site. The risk classification therefore specifies how great the danger of a person is due to a hazard site at the time t.

These time-dependent risk classifications for every person can be summarized in the form of an N×M matrix and a standard/metric can be derived therefrom that represents a time-dependent hazard value for the total system or for the safety system. In the simplest case, it can be a time-dependent maximum of the hazard or also a sum of all matrix entries. This numerical description of the total system now permits the use of known optimization algorithms.

In a further development of the invention, the safety system has a map or a map model and a navigation of the movable machine takes place in the map or map model.

The map model here can also have information on interfering influences such as blocks or congestion information.

In this respect, the comparison with accessible routes in a floor plan can also serve for the check. For this purpose that zone is marked as part of the configuration of the localization system in which mobile machines and persons can dwell at all, in particular walkable or travelable routes. A localization that is outside these zones will thus signal a systematic measurement error. The degree of plausibility is reduced by the determined inconsistency.

These configured zones can likewise be used to improve the position accuracy in that the position information is corrected such that it is within an accessible zone. This correction can optionally take place using past localizations and trajectory estimates, e.g. with the aid of a Kalman filter. A correction will reduce the degree of plausibility of a piece of position information since the correction introduces an additional unsafety factor.

Additional information can also be made usable here by considering preceding values. The correction of inconsistent position values can therefore take place in the direction of the last valid measurement or in accordance with a trajectory estimate.

A comparison of radio locations that were determined with the aid of independent or different subsets of the available radio stations or anchor points is furthermore possible

The method makes use of the fact that as a rule all of the radio stations or anchor points are not required for the determination of the position and thus a plausibilization is possible from the measurement data themselves in that the same localization work is carried out by two different subgroups of the stationary radio stations. A cross-comparison with the expectation of the agreement is checked here as in the comparison of independent measurements of different radio transponders.

In a further development of the invention, at least two respective radio transponders are arranged at the objects, with the two radio transponders being arranged spaced apart from one another and with the control and evaluation unit being configured to compare the position data of the radio transponders cyclically and to form cyclically checked position of the objects.

The invention provides position data that can be used in a technical safety manner. This means that the position data of all persons and hazard sites thus acquired can be used as the basis for a comprehensive, forward-looking, and productivity optimizing securing concept.

The position tracking takes place by means of radio location. The objects are provided with radio transponders via which a localization signal is regularly transmitted to the fixed position radio stations and a position or real time position of the respective object is generated or formed in the control and evaluation unit or in a central control.

In accordance with the invention, the position information of a large number or of all of the mobile objects or mobile participants are available in real time in an industrial work environment.

Since at least two respective radio transponders are arranged at the respective object, errors in the localization information can be avoided since namely the localization information is always available from at least two independent radio transponders. The localization and the formed position signal are thus usable in the sense of functional safety. It is thus possible to discover and avoid erroneous localizations and to improve the quality of the spatial information.

A safety situation can be evaluated by the control and evaluation unit on the basis of a plurality or of a large number of checked position data or position information. This zone orientated or space oriented securing thereby provides the possibility of further risk reduction measures.

The present invention thus also makes it possible in the event of error prone radio location information to make a check in the operating environment such that it can be used in a technical safety manner in the sense of machine safety. It is discovered in this process when localization errors occur outside a specified tolerance range, for example due to radio signals being too weak. Defective localization information is corrected where possible in this process and is made usable for further use. If this is not possible, an error control measure is initiated; the position value is marked as erroneous, for example.

The localization information, position information, or position data present are thus checked with respect to their reliability. A degree of reliability required for the further use can furthermore be associated with the position data.

The previously customary strategy in accordance with the prior art, according to which a machine is shut down or slowed down on the presence of a person in a hazard zone, can admittedly also be provided in accordance with the invention, but it is also possible to avoid a shutting down or a direct slowing down with the present invention since more information on the total situation and positions of the objects is present.

The localization of the radio transponders takes place by time of flight measurements of radio signals that are cyclically exchanged between the radio transponders and a plurality of fixed position radio stations. This triangulation works very well when the signals are transmitted at a sufficient signal strength and on a straight or direct propagation path. Since this does not always have to be the case, a cross-comparison is now made between the position information of the radio transponders determined in this manner.

A redundant position determination with at least two radio transponders is provided for technical safety reasons. Since the radio transponders are small and relatively inexpensive, this error control measure is simple to implement and is very effective with respect to the error control.

The positions of both radio transponders of an object are generally continuously determined and compared with one another in principle. A series of critical error cases can be controlled by the comparison of the positions of the radio transponders and in particular by the comparison with a known expectation, namely the spacing of the radio transponders in an expected zone.

An error according to which a radio transponder no longer delivers any position information is discovered and controlled. An error according to which the signals of the radio transponders are poor and are subject to a large systematic error is discovered and controlled. An error according to which a synchronization of the radio transponders is no longer possible is discovered and controlled.

In the sense of the invention, the positions are therefore determined by means of radio location for at least two radio transponders in a spaced apart arrangement and are compared with the expectation of a known spaced apart arrangement.

In a further development of the invention, sequence steps and/or process steps of the machine or plant are read by the control and evaluation unit.

Sequence steps and/or process steps planned for the future are thereby known to the control and evaluation unit and can be used for a forward-looking response and thus for a forward-looking influencing of the machine and/or of the mobile objects.

The sequence steps and/or process steps are here present, for example, in the form of programs or scripts that can be read by the control and evaluation unit. The programs are, for example, programs of a programmable logic controller.

In a further development of the invention, at least one job planning for the plant and target coordinates of the mobile vehicles are read by the control and evaluation unit.

Sequence steps and/or process steps planned for the future are thereby known to the control and evaluation unit on the basis of the job planning and the target coordinates of the mobile objects or mobile vehicles and can be used for a forward-looking response and thus for a forward-looking influencing of the machine and/or of the mobile objects.

In a further development of the invention, the safety system has a database, with the database having data on the dwell probability of the objects and a time and/or space frequency distribution of the objects.

In accordance with the further development of the invention, statistical information that was derived from the observation of past routines can be generated and evaluated.

For example, frequently traveled routes and less frequently traveled routes of the mobile objects are known to the control and evaluation unit, whereby a possible risk for persons can be estimated better and with a higher probability. A possible risk to persons can be estimated better and with a higher probability due to the known dwell probabilities since, for example, mobile objects or mobile vehicles can travel at higher speeds at points with a small dwell possibility of persons than in zones in which persons will dwell with a high probability.

In a further development of the invention, a degree of productivity of the plant, of the machine, and/or of the objects is detected by means of the control and evaluation unit.

A degree of productivity is defined as an optimization parameter in addition to the already known risk classifications. In the simplest case, an accumulated shutdown time of the productive routines or a process cycle time is used here. The use of throughput rates of travel routes, energy, and/or resource consumption is, however, also possible.

While taking account of a marginal condition that a standard of the risk classification for a person always has to be below a limit value that represents a tolerable risk, the degree of productivity is optimized with the aid of the variation of the trajectories or paths or other process parameters. This can be carried out, for example, using variation approaches or with a simple testing of the available trajectories and process parameters. The primary optimization value is the productivity.

In addition, the risk classification itself can enter into the optimization to reduce the total risk. This is of interest, for example, when there are a plurality of alternative trajectories that result in a comparable productivity, for instance when a mobile object has two possibilities of reaching a target point, with, for example, the mobile object coming into the proximity of a single person on a first route and the mobile object coming into the proximity of a plurality of persons on the second alternative route. The total risk is here lower on the first route than on the second route having more persons that can be put at risk.

It is decisive here that the trajectories of the individual participants are not reactionless, i.e. can have an influence on the risk classification of other persons. The optimization therefore sensibly takes place in the total system.

In a further development of the invention, warnings are output to the persons by means of at least one display unit.

An improved system state is achieved by warnings or instructions by means of the display unit.

It can thus be dynamically displayed by means of a display unit, for example for a zone, whether a presence of persons in this zone is allowed or not. Routes recommended for persons can furthermore be displayed or a warning against non-recommended routes can be given by means of the display unit, for example.

In a further development of the invention, the control and evaluation unit is configured to control and thus to influence the machine and/or the mobile vehicle.

The optimum system state is achieved by a control of machines and process routines.

The effectiveness of the different effects and their influence on productivity differ here and are used for a prioritization of the measures. It must, for example, be anticipated that a warning to a person or the instruction to take an alternative route is ignored by persons. On a directly impending risk, use is therefore made of the very much more reliable controls of the machines, e.g. a slowing down of the machine or an emergency stop of the machine.

An evaluation is here made at every point in time from the observation of the time development of the safety system whether the safety system is optimized and whether the constraints according to which a risk can be tolerated is observed. This evaluation enters as feedback into the selection of the control measures.

The following possibilities are provided for the influencing, for example:
an emergency stop of a machine or of a moving object or vehicle;
a slowing down of a machine or of a moving object or vehicle;
a change of a path plan of a person or of a moving object or vehicle
a change of an order of individual process steps of an automation routine;
warnings to a person;
instructions to a person, e.g. indications of an alternative travel path.

In a further development of the invention, plausibility values are formed on the basis of the detected signal strengths of the radio signals of the radio transponders and from the comparison of the position data of the radio transponders.

A degree of plausibility that enters into the further use of the position data or of the position information is derived as a result of the consistency check. A position value that is confirmed by different independent sources with a small relativity error is given a very high plausibility value in this process. If, in contrast, there are large deviations of the independent measurements from one another or if measurement values are missing or implausible, a low plausibility value is associated with these measurements.

A check is made in this process whether the measured positions coincide with a known configuration within the framework of a specified tolerance or whether there are significant deviations. A plausibility code of the radio location for this measurement cycle is set in dependence on the degree of coincidence. A high plausibility value therefore means a good coincidence between expectation and measurement, while a small plausibility value signals a defective measurement. This plausibility number can be used for the further processing in a safety related function as “safety-related confidence information” in accordance with IEC62998-1.

In a further development of the invention, the spacings between the radio transponders are known to the control and evaluation unit and are stored in a memory of the control and evaluation unit.

It is thereby possible to teach and store different objects having individual distances of the radio transponders so that the safety system can identify stored objects and can distinguish them from non-stored objects.

In a further development of the invention, the spacings between the radio transponders vary or are variable for a person due to the movement of the person.

The spacing of at least two radio transponders thereby varies cyclically as soon as the person moves, whereby the position detection of the radio transponders is dynamized and thereby becomes testable, whereby errors in the position detection and in the detection of the orientation are avoided. The spacing of two radio transponders that are each arranged on the shoulders of a person varies slightly, for example, when the person is walking since the position of the shoulder blades varies slightly.

The spacings of the radio transponders are thus variable, with the variable spacing also being known here. The spacing can, for example, be measured here, in particular cyclically measured.

In a further development of the invention, at least three radio transponders are arranged, with the control and evaluation unit being configured to form orientation data of the object from the position data of the radio transponders.

Two radio transponders are, for example, arranged at the shoulders of a vest of a person. A further transponder is, for example, arranged at a helmet of the person.

An overdetermined system is thereby advantageously present in a technical safety manner. Even if a radio transponder were to fail or if its radio signals were not detectable two radio transponders would still remain that can be evaluated redundantly. A highly available safety system is thereby present.

In a further development of the invention, at least four, at least six, or at least eight, radio transponders are arranged at the object, with two respective radio transponders each lying on a straight line, with the straight lines each being at an angle of 90°+/−15° to one another, in particular perpendicular to one another.

Radio transponders are thereby respectively arranged in pairs, with the respective pairs each having a different orientation. An orientation determination from every direction is thereby unique. Furthermore, a radio transponder can also be arranged at the point of intersection of the straight lines so that a single radio transponder forms a center or a central position point that can be used as a reference position.

In a further development of the invention, the radio transponders each have at least one time measurement unit, with the radio stations likewise respectively having at least one time measuring unit, with the radio stations being configured to read and/or describe the times of the time measurement units of the radio transponders and/or with the radio stations being configured to synchronize the times of the time measurement units of the radio transponders and/or with the radio stations being configured to compare the times of the time measurement units of the radio transponders with the times of the time measurement units of the radio stations.

A more precise position determination is thereby possible that can also be carried out permanently precisely by the synchronization.

In a further development of the invention, the safety system has optical systems for the localization and detection of the objects.

The position data or the position information can be compared with safe or unsafe position data or position information that were/was detected at spots at specific locations in the operating environment with the aid of optical sensors.

An example is the comparison with the position data that were determined in the field of vision of an optical sensor, for example a 3D camera. It can be in an intersection zone, for example. The position relative to the 3D camera is determined in this process on the detection of an object in the field of vision and the global position of the object is derived using the known position of the 3D camera. In this respect, both statically attached optical sensors and mobile optical sensors whose position and orientation are known through other sources are provided. A test is subsequently made as to whether an object that matches this position value is in a list of the objects tracked by means of radio location. On sufficient agreement, the position value of the radio location is deemed checked. In this case, a diverse redundant approach has confirmed the measurement.

The optical position data typically have a better accuracy and can additionally be used to improve the position accuracy of the person or of the mobile machine.

The plausibility of a position value is therefore the greater, the better the agreement between the optical position determination and the radio location and the less ambiguous the association between the optical position determination and the radio location is also possible. In the above-shown case, the additional difficulty can, for example, be present that it is not possible to reliably determine whether a first radio location does not possibly also belong to a second optical localization and vice versa. Such ambiguities are considered in the plausibility. This consideration can also take place in that the association is carried out in a safety related manner such that a minimal deviation between the radio location and the optical position results. It can alternatively also take place in that preceding position values are tracked and the association is made such that the interval from the preceding measurement is minimized.

In a further development of the invention, the safety system has radar sensors for the localization and detection of the objects.

The position data or the position information can be compared with safe or unsafe position data or position information that were/was detected at spots at specific locations in the operating environment with the aid of radar sensors.

An example is the comparison with the position data that were determined in the field of vision of a radar sensor, for example an area radar sensor. It can be in an intersection zone, for example. The position relative to the radar sensor is determined in this process on the detection of an object in the field of vision and the global position of the object is derived using the known position of the radar sensor. In this respect, both statically attached radar sensors and mobile radar sensors whose position and orientation are known through other sources are provided. A check is subsequently made as to whether an object that matches this position value or these position data is in a list of the objects tracked by means of radio location. On sufficient agreement, the position value of the radio location is deemed checked. In this case, a diverse redundant approach has confirmed the measurement.

The position data of the radar sensors typically have a greater range and can additionally be used to improve the position accuracy of the person or of the mobile machine.

The plausibility of a position value is therefore the greater, the better the agreement between the optical position determination and the radio location and the less ambiguous the association between the radar position determination and the radio location is also possible. In the above-shown case, the additional difficulty can, for example, be present that it is not possible to reliably determine whether a first radio location does not possibly also belong to a second radar localization and vice versa. Such ambiguities are considered in the plausibility. This consideration can also take place in that the association is carried out in a safety related manner such that a minimal deviation between the radio location and the radar localization results. It can alternatively also take place in that preceding position values are tracked and the association is made such that the interval from the preceding measurement is minimized.

In a further development of the invention, the safety system has RFID sensors for the localization and detection of the objects.

The position data or position information can be compared with safe or unsafe position data or position information that were/was detected at spots at specific locations in the operating environment with the aid of RFID sensors.

An example is the comparison with the position data that were determined in the field of vision of an RFID sensor. It can be in an intersection zone, for example. The position relative to the RFID sensor is determined in this process on the detection of an object in the field of vision and the global position of the object is derived using the known position of the RFID sensor. In this respect, both statically attached RFID sensors and mobile RFID sensors whose position and orientation are known through other sources are provided. A test is subsequently made as to whether an object that matches this position value is in a list of the objects tracked by means of radio location. On sufficient agreement, the position value of the radio location is deemed checked. In this case, a diverse redundant approach has confirmed the measurement.

The position data of the RFID sensors typically have a similar accuracy and can additionally be used to improve the position accuracy of the person or of the mobile machine.

The plausibility of a position value is therefore the greater, the better the agreement between the optical position determination and the radio location and the less ambiguous the association between the RFID sensor determination and the radio location is also possible. In the above-shown case, the additional difficulty can, for example, be present that it is not possible to reliably determine whether a first radio location does not possibly also belong to a second localization by means of an RFID sensor and vice versa. Such ambiguities are considered in the plausibility. This consideration can also take place in that the association is carried out in a safety related manner such that a minimal deviation between the radio location and the RFID sensor position results. It can alternatively also take place in that preceding position values are tracked and the association is made such that the interval from the preceding measurement is minimized.

In a further development of the invention, the safety system has ultrasound sensors for the localization and detection of the objects.

The position data can be compared with safe or unsafe position data or position information that were/was detected at spots at specific locations in the operating environment with the aid of ultrasound sensors.

An example is the comparison with the position data that were determined in the field of vision of an ultrasound sensor, for example an ultrasound area sensor. It can be in an intersection zone, for example. The position relative to the ultrasound sensor is determined in this process on the detection of an object in the field of vision and the global position of the object is derived using the known position of the ultrasound sensor. In this respect, both statically attached ultrasound sensors and mobile ultrasound sensors whose position and orientation are known through other sources are provided. A test is subsequently made as to whether an object that matches this position value is in a list of the objects tracked by means of radio location. On sufficient agreement, the position value of the radio location is deemed checked. In this case, a diverse redundant approach has confirmed the measurement.

The ultrasound sensors typically have a similar accuracy and can additionally be used to improve the position accuracy of the person or of the mobile machine.

The plausibility of a position value is therefore the greater, the better the agreement between the ultrasound sensor position determination and the radio location and the less ambiguous the association between the ultrasound position determination and the radio location is also possible. In the above-shown case, the additional difficulty can, for example, be present that it is not possible to reliably determine whether a first radio location does not possibly also belong to a second ultrasound localization and vice versa. Such ambiguities are considered in the plausibility. This consideration can also take place in that the association is carried out in a safety related manner such that a minimal deviation between the radio location and the optical position results. It can alternatively also take place in that preceding position values are tracked and the association is made such that the interval from the preceding measurement is minimized.

In a further development of the invention, the radio location system is an ultra wideband radio location system, with the frequency used being in the range from 3.1 GHz to 10.6 GHz, with the transmission energy per radio station amounting to a maximum of 0.5 mW.

An absolute bandwidth in an ultra wideband radio location system amounts to at least 500 MHz or a relative bandwidth amounts to at least 20% of the central frequency.

The range of such a radio location system amounts, for example, to 0 to 50 m. In this respect, the short time duration of the radio pulses is used for the localization.

The radio location system thus only transmits radio waves having a low energy. The system can be used very flexibly and has no interference.

A plurality of radio stations, for example more than three, are preferably arranged that monitor at least some of the movement zone of the person or of the object.

In a further development of the invention, a change of the safety function of the safety system takes place on the basis of the checked position data by means of the control and evaluation unit.

A change of the safety function of the safety function of the safety system takes place on the basis of position data by means of the control and evaluation unit.

If a predetermined position has been recognized that is stored, for example, the control and evaluation unit can switch over to a different protective measure or safety function. The switching over of the protective measure can comprise, for example, a switching over of measured data contours, a switching over of protected fields, a parameter or shape matching of measured data contours or protected fields, and/or a switching over of the properties of a protected field. The properties of a protected field include, for example, the resolution and/or the response time of the protected field. A switching over of the protective measure can also be a safety function such as a force restriction of the drive to which the switchover is made.

In a further development of the invention, a change of an order of process steps of an automation routine of a plant takes place on the basis of the checked position data by means of the control and evaluation unit.

In a further development of the invention, position data checked by means of the control and evaluation unit are checked for agreement with stored position data of a safe point of interest.

A check of the radio location can additionally optionally be carried out at specific monitoring points that, for example, deliver both optically determined position information and position information detected by radio location in the sense that a check is made as to whether a radio location has taken place at all for a detected object. Such a confirmation can reveal the safety critical error cases of a missing or non-functioning tag and can satisfy the demands on a cyclic test in the sense of the standard ISO 13849-1.

The comparison with independent position data can also take place at known interaction points. For example, by actuation of a switch or on a monitored passage through a door. At this moment, the position of the operator is very precisely known and can be used for a validation of the position data or of the position information. A corresponding process is also possible with autonomous vehicles. The position is very accurately known on docking at a charge station or on an arrival at transfer stations and can be used for checking the radio location and technical safety error control.

A comparison of radio locations that were determined with the aid of independent or different subsets of the available radio stations or anchor points is furthermore possible

The method makes use of the fact that as a rule all of the radio stations or anchor points are not required for the determination of the position and thus a plausibilization is possible from the measurement data themselves in that the same localization work is carried out by two different subgroups of the stationary radio stations. A cross-comparison with the expectation of the agreement is checked here as with the comparison of independent measurements of different radio transponders.

The invention will also be explained in the following with reference to further advantages and features and to the enclosed drawing with regard to embodiments. The Figures of the drawing show in:

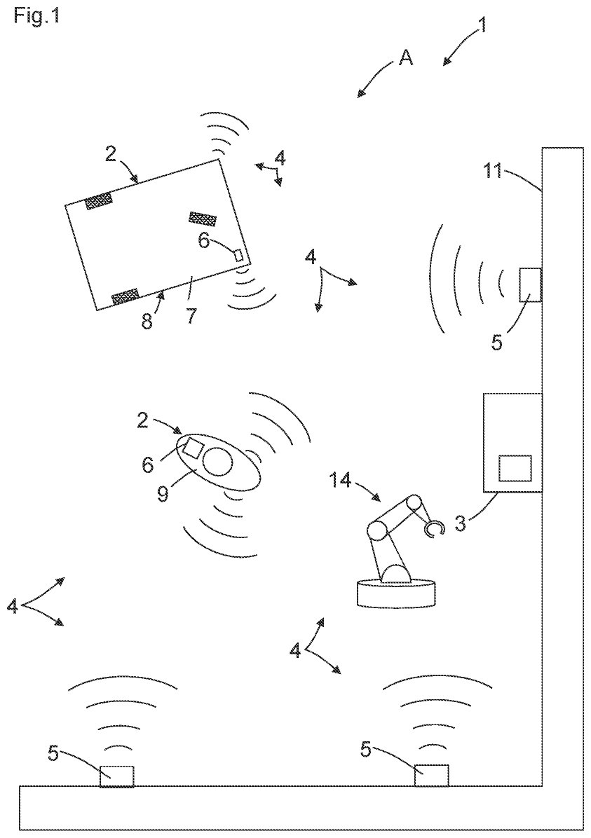

FIGS. 1 to 3 and a respective safety system for the localization of at least

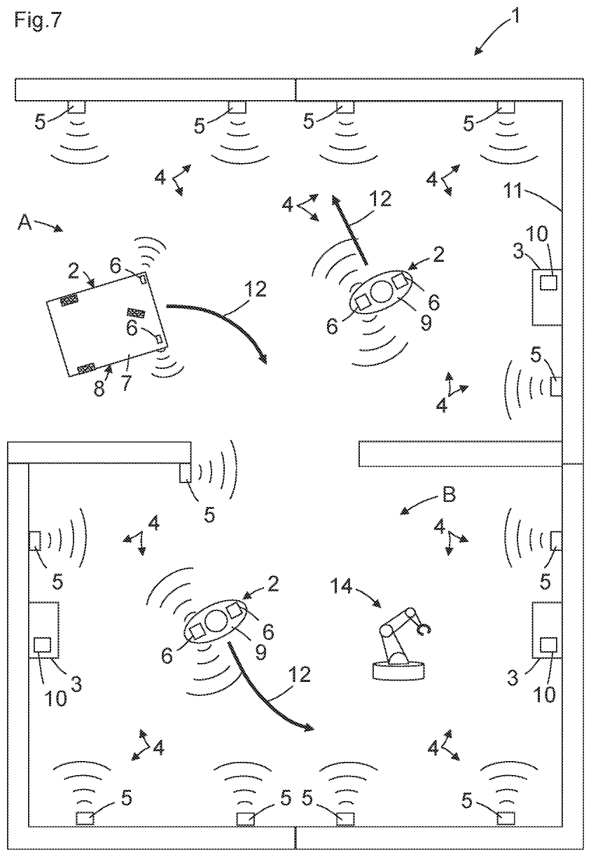

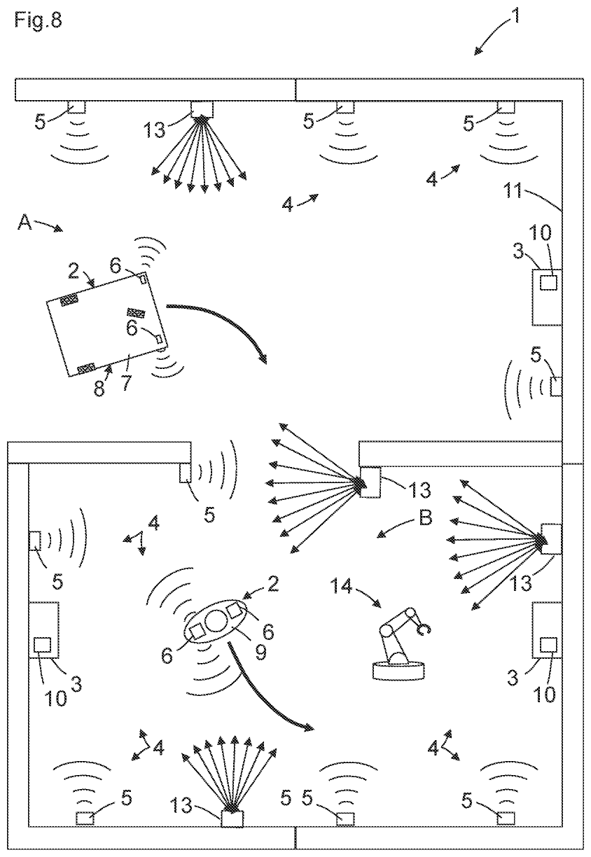

FIGS. 7 and 8 of at least two objects;

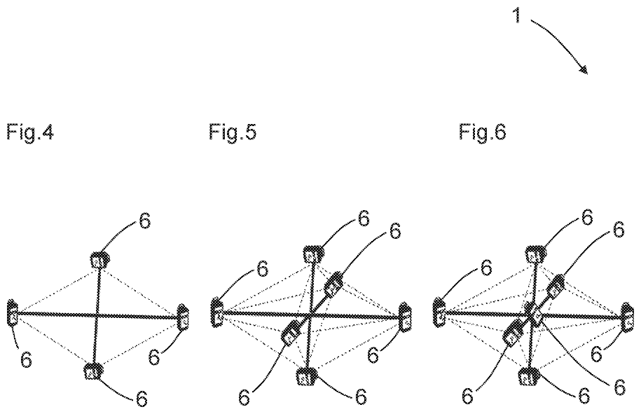

FIGS. 4 to 6 in each case a plurality of radio transponders at an object.

In the following Figures, identical parts are provided with identical reference numerals.

FIG. 1 shows a safety system 1 for localizing at least two objects 2 with varying locations, having at least one control and evaluation unit 3, having at least one radio location system 4, wherein the radio location system 4 has at least three arranged radio stations 5, wherein at least one respective radio transponder 6 is arranged at the objects 2, wherein position data of the radio transponder 6 and thus position data of the objects 2 can be determined by means of the radio location system 4, wherein the position data can be transmitted from the radio station 5 of the radio location system 4 to the control and evaluation unit 3 and/or the position data can be transmitted from the radio transponder 6 to the control and evaluation unit 3, wherein the control and evaluation unit 3 is configured to cyclically detect the position data of the radio transponders 6, wherein the radio transponders 6 have identification, wherein a respective radio transponder 6 is associated with a respective object 2, whereby the control and evaluation unit 3 is configured to distinguish the objects 2, and wherein the control and evaluation unit 3 is configured to associate a risk classification with each object 2 at least in dependence on the position of the object 2 from another object 2.

FIG. 1 likewise shows a safety system 1 for localizing at least two objects 2 with varying locations, having at least one control and evaluation unit 3, having at least one radio location system 4, wherein the radio location system 4 has at least three arranged radio stations 5, wherein at least one respective radio transponder 6 is arranged at the objects 2, wherein position data of the radio transponder 6 and thus position data of the objects 2 can be determined by means of the radio location system 4, wherein the position data can be transmitted from the radio station 5 of the radio location system 4 to the control and evaluation unit 3 and/or the position data can be transmitted from the radio transponder 6 to the control and evaluation unit 3, wherein the control and evaluation unit 3 is configured to cyclically detect the position data of the radio transponders 6, wherein first objects 2 are persons 9 and second objects 2 are mobile objects 7 or mobile vehicles 8, wherein the radio transponders 6 have identification, wherein a respective radio transponder 6 is at least associated with either a respective person 9 or a mobile object 7, whereby the control and evaluation unit 3 is configured to distinguish the persons 9 and mobile objects 7, and wherein the control and evaluation unit 3 is configured to associate a risk classification with each person 9 at least in dependence on the position of the person 7 with respect to at least one mobile object.

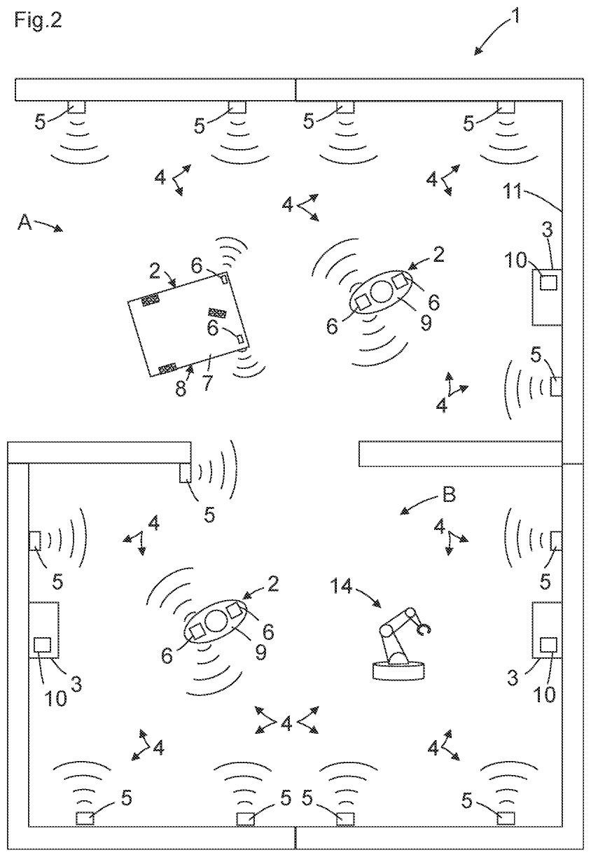

FIG. 2 shows two zones A and B that are connected to one another via a passage and that are connected to one another by means of boundaries or walls 11.

In accordance with FIG. 2, a securing is possible over larger zones A and B, that is, for example, of a large number of work stations, of a large number of robots, or, for example, of whole production facilities, since not only a local presence or approach of persons 9 is detected, but rather a position of a large number of persons 9 and mobile machines 8 active in an environment or zone A, B can be detected and can be continuously tracked. A plurality of radio stations 5 are provided for this purpose, for example.

In accordance with FIG. 2 a securing is possible over larger zones A and B, that is, for example, of a large number of machines and/or of a large number of robots, or, for example, even of whole production facilities, since not only a local presence or approach of persons 9 is detected, but rather a position of a large number of persons 9 and mobile objects 2 or mobile objects 7 active in an environment or zone A, B can be detected and can be continuously tracked.

in accordance with FIG. 2, possible future hazards can be discovered very much earlier since the control and evaluation unit 3 or the safety system 1 is simultaneously aware of the positions of a large number of objects 2 and likewise knows their cyclic time progression. Measures to reduce risk that intervene a great deal less invasively in the automation routines and that interfere less with productivity can thereby be carried out by the safety system 1.

In accordance with FIG. 2, position data usable in a technical safety manner are provided. This means that the position data of all the persons 9 and hazard sites thus acquired can be used as the basis for a comprehensive forward-looking and productivity-optimizing securing concept.

The position tracking takes place by means of radio location. The objects 2 are provided with radio transponders 6 via which a localization signal is regularly transmitted to the fixed position radio stations 5 and a position or real time position of the respective object 2 is generated or formed in the control and evaluation unit 3 or in a central control.

In accordance with FIG. 2, the position information of a large number or of all of the mobile objects 2 and fixed position objects 2 such as machines 14 or mobile participants are available in real time in an industrial work environment.

The localization of the radio transponders 6 takes place by time of flight measurements of radio signals that are cyclically exchanged between the radio transponders 6 and a plurality of fixed position radio stations 5. This triangulation works very well when the signals are transmitted at a sufficient signal strength and on a straight or direct propagation path.

In accordance with a first alternative of the invention, the signals of a radio transponder 6 are received by a plurality of fixed position radio stations 5 or anchor stations and the basis for the localization is created via a time of flight measurement, e.g. the time of arrival (TOA) or e.g. the time difference of arrival (TDOA). The calculation or estimation of the position of a radio transponder 6 then takes place on the control and evaluation unit 3, for example an RTLS (real time location system) server that is connected to all the radio stations or anchor stations via a wireless or wired data link. This mode of localization is called an RTLS (real time location system) mode.

Alternatively, the position information can, however, also be determined on each radio transponder 6. In this case, the safety system 1 works in a comparable manner to the GPS navigation system. Each radio transponder 6 receives the signals of the radio stations 5 or anchor stations that are transmitted at a fixed time relationship with one another. A position estimate of the radio transponders 6 can also be carried out here via the different time of flight measurements and the knowledge of the radio station positions or anchor positions. The radio transponder calculates its position itself and can transmit it to the RTLS server as required with the aid of the UWB signal or of other wireless data links.

In accordance with FIG. 2, measures for risk reduction are possible that enable a de-escalating sequence of measures that develop their effectiveness better due to a longer lead time and that also include the effect on the behavior of the persons involved.

The risk reduction used here preferably uses the position information of all the objects 2, that is of all the persons 9 and mobile objects 2, as a rule mobile vehicles and, for example, associated accuracy information as the input information.

In accordance with FIG. 2, information on the operating environment such as the knowledge of accessible zones, for example travel path of the mobile objects 7, and the positions of the hazard sites of the machines 14 are taken into account.

The movable object 7, a movable machine or mobile machine can, for example, be a guideless vehicle, a driverless vehicle, an autonomous vehicle, an automated guided vehicle (AGV), an autonomous mobile robot (AMR), an industrial mobile robot (IMR), or a robot having movable robot arms. The mobile machine thus has a drive and can be moved in different directions.

The person 9 can, for example, be an operator or a service engineer. The radio transponders 6 are arranged at the clothing or on the equipment of the person 8, for example. It can here, for example, be a vest to which the radio transponders 6 are firmly fixed. The radio transponders 6 are arranged, for example, at the shoulders and in the chest and back areas. The radio transponders 6 can, however, also be arranged at different locations on the person 9. Two radio transponders 6 are, for example, arranged at the shoulders of a vest of a person 9.

In accordance with FIG. 7, the control and evaluation unit 3 is configured to respectively determine a position of the radio transponders 6 at different points in time and to determine a speed, an acceleration, a direction of movement and/or at least one path (trajectory) of the radio transponders 6 or of the mobile objects 7 and persons 9 from it.

In accordance FIG. 7, the speeds and directions of movement of all the persons 9 and mobile objects 7 are preferably taken into account.

The position information serves for the calculation of probable movement sequences or trajectories of all the objects 2, that is the persons 9 or mobile objects 7.

A family of movement sequences is determined for each person 9 and for each mobile object 7 with the aid of position information and is provided with a degree of probability, for example. The degree of probability is here estimated, for example, on the basis of the distance covered and/or on the direction of movement. Short direct paths are thus, for example, more probable than long indirect paths. The degree of probability can furthermore be estimated on the basis of a known history of routes of the objects 2. Paths that were used often in the past, for example, are thus more probable than new routes. The degree of probability can furthermore be estimated on the basis of known problems. A disturbed possible route will thus more probably be avoided than a non-disturbed route.

The most probable path, route, or trajectory is selected from a family of possible trajectories and the probabilities associated with them for every person 9 and for every mobile object 7 or for every vehicle.

A trajectory selected for each of N persons 9 has a time-dependent risk classification assigned to it for each of M hazard sites that takes account of the spacing or the time-dependent spacing from hazard sites and optionally from details of the automation routines. In the simplest case, the risk can be determined binarily with an approach threshold to a hazard site. The risk classification therefore specifies how great the danger of a person 9 is due to a hazard site at the time t.

These time-dependent risk classifications for every person 9 can be summarized in the form of an N×M matrix and a standard/metric can be derived therefrom that represents a time-dependent hazard value for the total system or for the safety system 1. In the simplest case, it can be a time-dependent maximum of the hazard or also a sum of all matrix entries. This numerical description of the total system now permits the use of known optimization algorithms.

In accordance with FIG. 7, the safety system has a map or a map model and a navigation of the movable machine 14 takes place in the map or map model.

The map model here can also have information on interfering influences such as blocks or congestion information.

In this respect, the comparison with accessible routes in a floor plan can also serve for the check. For this purpose that zone is marked as part of the configuration of the localization system in which mobile machines 14 and persons 9 can dwell at all, in particular walkable or travelable routes. A localization that is outside these zones will thus signal a systematic measurement error. The degree of plausibility is reduced by the determined inconsistency.

These configured zones can likewise be used to improve the position accuracy in that the position information is corrected such that it is within an accessible zone. This correction can optionally take place using past localizations and trajectory estimates, e.g. with the aid of a Kalman filter. A correction will reduce the degree of plausibility of a piece of position information since the correction introduces an additional unsafety factor.

Additional information can also be made usable here by considering preceding values. The correction of inconsistent position values can therefore take place in the direction of the last valid measurement or in accordance with a trajectory estimate.

A comparison of radio locations that were determined with the aid of independent or different subsets of the available radio stations or anchor points is furthermore possible

The method makes use of the fact that as a rule all of the radio stations 5 or anchor points are not required for the determination of the position and thus a plausibilization is possible from the measurement data themselves in that the same localization work is carried out by two different subgroups of the stationary radio stations. A cross-comparison with the expectation of the agreement is checked here as with the comparison of independent measurements of different radio transponders.

In accordance with FIG. 2, at least two respective radio transponders 6 are arranged at the objects 2, with the two radio transponders 6 being arranged spaced apart from one another and with the control and evaluation unit 3 being configured to cyclically compare the position data of the radio transponders 6 and to form cyclically checked position data of the objects 2.

In accordance with FIG. 2, the safety system 1 thus provides position data usable in a technical safety manner. This means that the position data of all the persons 9 and hazard sites thus acquired can be used as the basis for a comprehensive forward-looking and productivity-optimizing securing concept.

The position tracking takes place by means of radio location. The objects 2 are provided with radio transponders 6 via which a localization signal is regularly transmitted to the fixed position radio stations 5 and a position or real time position of the respective object 2 is generated or formed in the control and evaluation unit 3 or in a central control.

In accordance with FIG. 2, the position information of a large number or of all of the mobile objects or mobile participants are available in real time in an industrial work environment.

Since at least two respective radio transponders 6 are arranged at the respective object errors in the localization information can be avoided since namely the localization information is always available from at least two independent radio transponders 6. The localization and the formed position signal is thus usable in the sense of functional safety. It is thus possible to discover and avoid erroneous localizations and to improve the quality of the spatial information.

The safety system 1 in accordance with FIG. 2 thus also makes it possible in the event of error prone radio location information to make a check in the operating environment such that it can be used in a technical safety manner in the sense of machine safety. It is discovered in this process when localization errors occur outside a specified tolerance range, for example due to radio signals being too weak. Defective localization information is corrected where possible in this process and is made usable for further use. If this is not possible, an error control measure is initiated; the position value is marked as erroneous, for example.

The localization information, position information, or position data present are thus checked with respect to their reliability. A degree of reliability required for the further use can furthermore be associated with the position data.

The localization of the radio transponders 6 takes place by time of flight measurements of radio signals that are cyclically exchanged between the radio transponders 6 and a plurality of fixed position radio stations 5. This triangulation works very well when the signals are transmitted at a sufficient signal strength and on a straight or direct propagation path. Since this does not always have to be the case, a cross-comparison is now made between the position information of the radio transponders 6 determined in this manner.

A redundant position determination with at least two radio transponders 6 is optionally provided for technical safety reasons. Since the radio transponders are 6 small and relatively inexpensive, this error control measure is simple to implement and is very effective with respect to the error control.

The positions of both radio transponders 6 of an object 2 are generally continuously determined and compared with one another in principle. A series of critical error cases can be controlled by the comparison of the positions of the radio transponders 6 and in particular by the comparison with a known expectation, namely the spacing of the radio transponders 6 in an expected zone.

In accordance with FIG. 2, the positions are therefore determined by means of radio location for at least two radio transponders 6 in a spaced apart arrangement and are compared with the expectation of a known spaced apart arrangement.

In accordance with FIG. 2, sequence steps and/or process steps of the machine 14 or plant are read by the control and evaluation unit 3.

Sequence steps and/or process steps planned for the future are thereby known to the control and evaluation unit 3 and can be used for a forward-looking response and thus for a forward-looking influencing of the machine 14 and/or of the mobile objects 7.

The sequence steps and/or process steps are here present, for example, in the form of programs or scripts that can be read by the control and evaluation unit 3. The programs are, for example, programs of a programmable logic controller.

In accordance with FIG. 2, at least one job planning for the plant and target coordinates of the mobile objects 7 or vehicles are read by the control and evaluation unit 3.

Planned sequence steps and/or process steps planned for the future are thereby known to the control and evaluation unit 3 on the basis of the job planning and the target coordinates of the mobile objects 7 or mobile vehicles and can be used for a forward-looking response and thus for a forward-looking influencing of the machine 14 and/or of the mobile objects 7.

In accordance with FIG. 2, the safety system 1 optionally has a database, with the database having data on the dwell probability of the objects 2 and a time and/or space frequency distribution of the objects 2.

Statistical information that was derived from the observation of past routines can thereby be generated and evaluated.

For example, frequently traveled routes and less frequently traveled routes of the mobile objects 7 are known to the control and evaluation unit 3 whereby a possible risk for persons 9 can be estimated better and with a higher probability. A possible risk to persons 9 can be estimated better and with a higher probability due to the known dwell probabilities since, for example, mobile objects 7 or mobile vehicles can travel at higher speeds at points with a small dwell possibility of persons 9 than in zones A, B in which persons 9 will dwell with a high probability.

In accordance with FIG. 2, a degree of productivity of the plant, of the machine 14, and/or of the objects 2 is detected by means of the control and evaluation unit 3.

A degree of productivity is defined as an optimization parameter in addition to the already known risk classifications. In the simplest case, an accumulated shutdown time of the productive routines or a process cycle time is used here. The use of throughput rates of travel routes, energy, and/or resource consumption is, however, also possible.

While taking account of a marginal condition that a standard of the risk classification for each person 9 always has to be below a limit value that represents a tolerable risk, the degree of productivity is optimized with the aid of the variation of the trajectories or paths or other process parameters. This can be carried out, for example, using variation approaches or with a simple testing of the available trajectories and process parameters. The primary optimization value is the productivity.

In addition, the risk classification itself can enter into the optimization to reduce the total risk. This is of interest, for example, when there are a plurality of alternative trajectories that result in a comparable productivity, for instance when a mobile object 7 has two possibilities of reaching a target point, with, for example, the mobile object 7 coming into the proximity of a single person 9 on a first route and the mobile object 7 coming into the proximity of a plurality of persons 9 on the second alternative route. The total risk is here lower on the first route than on the second route having more persons 9 that can be put at risk.

It is decisive here that the trajectories of the individual participants are not reactionless, i.e. can have an influence on the risk classification of other persons 9. The optimization therefore sensibly takes place in the total system.

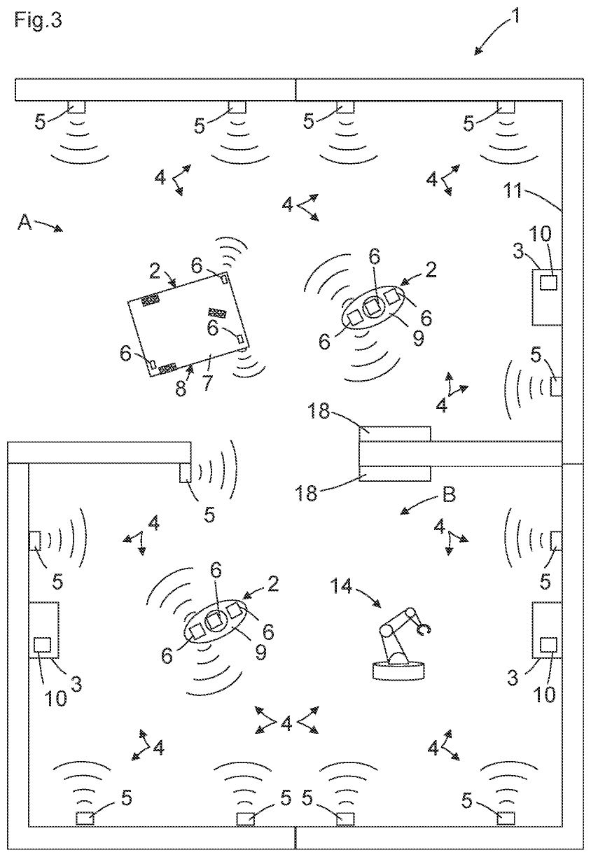

in accordance with FIG. 3, warnings are output to the persons 9 by means of at least one display unit 18.

An improved system state is achieved by warnings or instructions by means of the display unit 18.

It can thus be dynamically displayed, for example, for a zone by means of a display unit 18 whether a presence of persons 9 in this zone A, B is allowed or not. Routes recommended for persons 9 can furthermore be displayed or a warning against non-recommended routes can be given by means of the display unit 18, for example.

In accordance with the Figures, the control and evaluation unit 3 is configured to control and thus to influence the machine 14 and/or the mobile object 7 or the vehicle.

The optimum system state is achieved by a control of machines 14 and process routines.

The effectiveness of the different effects and their influence on the productivity differ here and are used for a prioritization of the measures. It must, for example, be anticipated that a warning to a person 9 or the instruction to take an alternative route is ignored by persons 9. On a directly impending risk, use is therefore made of the very much more reliable controls of the machines 14, e.g. a slowing down of the machine 14 or an emergency stop of the machine 14.

An evaluation is here made at every point in time from the observation of the time development of the safety system 1 whether the safety system 1 is optimized and whether the constraints according to which a risk can be tolerated is observed. This evaluation enters as feedback into the selection of the control measures.

In accordance with FIG. 2, plausibility values are formed on the basis of the detected signal strengths of the radio signals of the radio transponders 6 and from the comparison of the position data of the radio transponders 6.

A degree of plausibility that enters into the further use of the position data or of the position information is derived as a result of the consistency check. A position value that is confirmed by different independent sources with a small relativity error is given a very high plausibility value in this process. If, in contrast, there are large deviations of the independent measurements from one another or if measurement values are missing or implausible, a low plausibility value is associated with these measurements.

A check is made in this process whether the measured positions coincide with a known configuration within the framework of a specified tolerance or whether there are significant deviations. A plausibility code of the radio location for this measurement cycle is set in dependence on the degree of coincidence. A high plausibility value therefore means a good coincidence between expectation and measurement, while a small plausibility value signals a defective measurement. This plausibility number can be used for the further processing in a safety related function as “safety-related confidence information” in accordance with IEC62998-1.

In accordance with FIG. 2, the spacings between the radio transponders 6 are known to the control and evaluation unit 3 and are stored in a memory 10 of the control and evaluation unit 3.

It is thereby possible to teach and store different objects 2 having individual spacings of the radio transponders 6 so that the safety system 1 can identify stored objects 2 and can distinguish them from nonstored objects 2.

In accordance with FIG. 2, the spacings between the radio transponders 6 are variable for a person 9 due to the movement of the person 9.

The spacing of at least two radio transponders 6 thereby varies cyclically as soon as the person 9 moves, whereby the position detection of the radio transponders 6 is dynamized and thereby becomes testable, whereby errors in the position detection and in the detection of the orientation are avoided. The spacing of two radio transponders 6 that are each arranged on the shoulders of a person 9 varies slightly, for example, when the person 9 is walking since the position of the shoulder blades varies slightly.

The distances of the radio transponders 6 are thus variable, with the variable spacing also being known here. The spacing can, for example, be measured here, in particular cyclically measured.

In accordance with FIG. 3, at least three radio transponders 6 are arranged, with the control and evaluation unit 3 being configured to form orientation data of the object 2 from the position data of the radio transponders 6.

Two radio transponders 6 are, for example, arranged at the shoulders of a vest of a person 9. A further radio transponder 6 is, for example, arranged at a helmet of the person 9.

An overdetermined system is thereby advantageously present in a technical safety manner. Even if a radio transponder 6 were to fail or if its radio signals were not detectable, two radio transponders 6 would still remain that can be evaluated redundantly. A highly available safety system 1 is thereby present.

In accordance with FIG. 4 at least four, in accordance with FIG. 5 at least six, or in accordance with FIG. 6 at least eight radio transponders 6 are arranged at the object, with two respective radio transponders 6 each lying on a straight line, with the straight lines each being in particular perpendicular to one another.

Radio transponders 6 are thereby respectively arranged in pairs, with the respective pairs each having a different orientation. An orientation determination from every direction is thereby unique. Furthermore, a radio transponder 6 can also be arranged at the point of intersection of the straight lines so that a single radio transponder 6 forms a center or a central position point that can be used as a reference position.

In accordance with FIG. 7, the radio transponders 6 each have at least one time measurement unit, with the radio stations 5 likewise respectively having at least one time measuring unit, with the radio stations 5 being configured to read and describe the times of the time measurement units of the radio transponders 6 and with the radio stations 5 being configured to synchronize the times of the time measurement units of the radio transponders 6 and with the radio stations 5 being configured to compare the times of the time measurement units of the radio transponders 6 with the times of the time measurement units of the radio stations 5.

A more precise position determination is thereby possible that can also be carried out permanently precisely by the synchronization.

In accordance with FIG. 8, the safety system 1 has RFID sensors 13 for the localization and detection of the objects 2.

The position data or the position information can be compared with safe or unsafe position data or position information that were/was detected at spots at specific locations in the operating environment with the aid of optical sensors 13.

An example is the comparison with the position data that were determined in the field of vision of an optical sensor 13, for example a 3D camera. It can be in an intersection zone, for example. The position relative to the 3D camera is determined in this process on the detection of an object 2 in the field of vision and the global position of the object 2 is derived using the known position of the 3D camera. In this respect, both statically attached optical sensors 13 and mobile optical sensors 12 whose position and orientation are known through other sources are provided. A check is subsequently made as to whether an object 2 that matches this position value is in a list of the objects 2 tracked by means of radio location. On sufficient agreement, the position value of the radio location is deemed checked. In this case, a diverse redundant approach has confirmed the measurement.

The optical position data typically have a better accuracy and can additionally be used to improve the position accuracy of the person 9 or of the mobile objects 7.

The plausibility of a position value is therefore the greater, the better the agreement between the optical position determination and the radio location and the less ambiguous the association between the optical position determination and the radio location is also possible. In the above-shown case, the additional difficulty can, for example, be present that it is not possible to reliably determine whether a first radio location does not possibly also belong to a second optical localization and vice versa. Such ambiguities are considered in the plausibility. This consideration can also take place in that the association is carried out in a safety related manner such that a minimal deviation between the radio location and the optical position results. It can alternatively also take place in that preceding position values are tracked and the association is made such that the spacing from the preceding measurement is minimized.

In accordance with an embodiment that is not shown, the safety system 1 has radar sensors, RFID sensors, and/or ultrasound sensors for localizing and detecting the objects.

In accordance with FIG. 2, the radio location system 4 is optionally an ultrawide band radio location system, with the frequency used being in the range from 3.1 GHz to 10.6 GHz, with the transmission energy per radio station amounting to a maximum of 0.5 mW.

An absolute bandwidth in an ultra wideband radio location system amounts to at least 500 MHz or a relative bandwidth amounts to at least 20% of the central frequency.

The range of such a radio location system 4 amounts, for example, to 0 to 50 m. In this respect, the short time duration of the radio pulses is used for the localization.

The radio location system 4 thus only transmits radio waves having a low energy. The system can be used very flexibly and has no interference.

A plurality of radio stations 5, for example more than three, are preferably arranged in accordance with FIG. 2 that monitor at least some of the movement zone of the person 9 or object 2.

In accordance with FIG. 2, a change of the safety function of the safety system 1 optionally takes place on the basis, for example, of the checked position data by means of the control and evaluation unit 3.

If, for example, a predetermined position has been recognized that is stored, for example, the control and evaluation unit 3 can switch over to a different protective measure or safety function. The switching over of the protective measure can comprise, for example, a switching over of measured data contours, a switching over of protected fields, a parameter or shape matching of measured data contours or protected fields, and/or a switching over of the properties of a protected field. The properties of a protected field include, for example, the resolution and/or the response time of the protected field. A switching over of the protective measure can also be a safety function such as a force restriction of the drive to which the switchover is made.

In accordance with FIG. 2, for example, position data checked by means of the control and evaluation unit 3 are checked for agreement with stored position data of a safe point of interest.

A check of the radio location can additionally optionally be carried out at specific monitoring points that, for example, deliver both optically determined position information and position information detected by radio location in the sense that a check is made as to whether a radio location has taken place at all for a detected object 2. Such a confirmation can reveal the safety critical error cases of a missing or non-functioning tag and can satisfy the demands on a cyclic test in the sense of the standard ISO 13849-1.

The comparison with independent position data can also take place at known interaction points. For example, by actuation of a switch or on a monitored passage through a door or a passage in accordance with FIG. 2. At this moment, the position of the operator is very precisely known and can be used for a validation of the position data or of the position information. A corresponding process is also possible with autonomous vehicles. The position is very accurately known on docking at a charge station or on an arrival at transfer stations and can be used for checking the radio location and technical safety error control.

A comparison of radio locations that were determined with the aid of independent or different subsets of the available radio stations 5 or anchor points is furthermore possible

The method makes use of the fact that as a rule all of the radio stations 5 or anchor points are not required for the determination of the position and thus a plausibilization is possible from the measurement data themselves in that the same localization work is carried out by two different subgroups of the stationary radio stations. A cross-comparison with the expectation of the agreement is checked here as with the comparison of independent measurements of different radio transponders.

### REFERENCE NUMERALS

1 safety system
2 object
3 control and evaluation unit
4 radio location system
5 radio stations
6 radio transponder
7 mobile objects
8 mobile vehicles
9 person
10 memory
11 wall/boundary
12 path/trajectory
13 optical sensor
14 machine
18 display unit
A zone
B zone

1. A safety system for localizing at least two objects with variable locations, the safety system comprising at least one control and evaluation unit, having at least one radio location system,
wherein the radio location system has at least three arranged radio stations;
wherein at least one respective radio transponder is arranged at the objects;
wherein position data of the radio transponder and thus position data of the objects can be determined by means of the radio location system;
wherein the position data can be transmitted from the radio station of the radio location system to the control and evaluation unit;
and/or wherein the position data can be transmitted from the radio transponder to the control and evaluation unit,
wherein the control and evaluation unit is configured to cyclically detect the position data of the radio transponders, with the radio transponders having identification, with a respective radio transponder being associated with a respective object, whereby the control and evaluation unit is configured to distinguish the objects; and
with the control and evaluation unit being configured to associate a risk classification with each object at least in dependence on the position of the object with respect to another object.

2. The safety system in accordance with claim 1, wherein first objects are mobile objects and second objects are mobile objects,
with the radio transponders having identification, and with a respective radio transponder being associated with a mobile object, whereby the control and evaluation unit is configured to distinguish the mobile objects; and
with the control and evaluation unit being configured to associate a risk classification with each mobile object at least in dependence on the position of a mobile object with respect to at least one other mobile object.

3. The safety system in accordance with claim 1, wherein first objects are persons and second objects are mobile objects,
with the radio transponders having identification, and with a respective radio transponder being associated with at least one person and a respective radio transponder being associated with at least one mobile object, whereby the control and evaluation unit is configured to distinguish the persons and mobile objects; and
with the control and evaluation unit being configured to associate a risk classification with each person at least in dependence on the position of the person with respect to at least one mobile object.

4. The safety system in accordance with claim 1, wherein at least one fixed position machine of a plant having a hazard site of the machine is present, with the position of the fixed position hazard site being known to the control and evaluation unit.

5. The safety system in accordance with claim 1, wherein the control and evaluation unit is configured to respectively determine a position of the radio transponders at different points in time and to determine a speed, an acceleration, a direction of movement, and/or a path or a trajectory of the radio transponders from it.

6. The safety system in accordance with claim 1, wherein the safety system has a map or a map model; and wherein a navigation of the movable machine takes place in the map or in the map model.

7. The safety system in accordance with claim 1, wherein at least two respective radio transponders are arranged at the objects, with the two radio transponders being arranged spaced apart from one another and with the control and evaluation unit being configured to cyclically compare the position data of the radio transponders and to form cyclically checked position data of the objects.

8. The safety system in accordance with claim 1, wherein sequence steps and/or process steps of the machine or plant are read by the control and evaluation unit.

9. The safety system in accordance with claim 1, wherein at least one order planning for the plant and target coordinates of the mobile vehicles are read by the control and evaluation unit.

10. The safety system in accordance with claim 1, wherein the safety system has a database, with the database having data on the dwell probability of the objects and a time and/or space frequency distribution of the objects.

11. The safety system in accordance with claim 1, wherein a degree of productivity of the plant, of the machine, and/or of the objects is detected by means of the control and evaluation unit.

12. The safety system in accordance with claim 1, wherein warnings are output to the persons by means of at least one display unit.

13. The safety system in accordance with claim 1, wherein the control and evaluation unit is configured to control and thus to influence the machine and/or the mobile vehicle.

14. The safety system in accordance with claim 1, wherein plausibility values are formed on the basis of the detected signal strengths of the radio signals of the radio transponders and from the comparison of the position data of the radio transponders.

15. The safety system in accordance with claim 1, wherein the spacings between the radio transponders are known to the control and evaluation unit and are stored in a memory of the control and evaluation unit.

16. The safety system in accordance with claim 1, wherein the spacings between the radio transponders vary or are variable in a person due to the movement of the person.

17. The safety system In accordance with claim 1, wherein at least three radio transponders are arranged, with the control and evaluation unit being configured to form orientation data of the object from the position data of the radio transponders

18. The safety system in accordance with claim 1, wherein one of at least four, at least six, and at least eight, radio transponders are arranged at the object, with two respective transponders being disposed on a respective one straight line, with the straight lines each being at an angle of 90°+/−15° to one another.

19. The safety system in accordance with claim 1, wherein the radio transponders each have at least one time measurement unit, with the radio stations likewise respectively having at least one time measuring unit, with the radio stations being configured to read and/or describe the times of the time measurement units of the radio transponders and with the radio stations being configured to synchronize the times of the time measurement units of the radio transponders and with the radio stations being configured to compare the times of the time measurement units of the radio transponders with the times of the time measurement units of the radio stations.

20. The safety system in accordance with claim 1, wherein the safety system has optical sensors for localizing and detecting the objects.

21. The safety system in accordance with claim 1, wherein the safety system has radar sensor for localizing and detecting the objects.

22. The safety system in accordance with claim 1, wherein the safety system has RFID sensors for localizing and detecting the objects.

23. The safety system in accordance with claim 1, wherein the safety system has ultrasound sensors for localizing and detecting the objects.

24. The safety system in accordance with claim 1, wherein the radio location system is an ultra-wideband radio location system, with the frequency used being in the range from 3.1 GHz to 10.6 GHz, with the transmission energy per radio station amounting to a maximum of 0.5 mW.

25. The safety system in accordance with claim 1, wherein a change of the safety function of the safety system takes place by means of the control and evaluation unit based on the checked position data.

26. The safety system in accordance with claim 1, wherein a change of an order of process steps of an automation routine of a plant takes place by means of the control and evaluation unit based on the checked position data.

27. The safety system in accordance with claim 1, wherein position data checked by means of the control and evaluation unit controller are checked for agreement with stored position data of a safe point of interest.

28. A method having a safety system for localizing at least two objects with variable locations, the safety system having at least one control and evaluation unit,
wherein the radio location system has at least three arranged radio stations;
wherein at least one radio transponder is arranged at the objects;
wherein position data of the radio transponder and thus position data of the objects are determined by means of the radio location system;
wherein the position data are transmitted from the radio station of the radio location system to the control and evaluation unit,
and/or wherein the position data are transmitted from the radio transponder to the control and evaluation unit,
characterized in that
the control and evaluation unit is configured to cyclically detect the position data of the radio transponders,
with the radio transponders having identification, and with a respective radio transponder being associated with a respective object, whereby the control and evaluation unit is configured to distinguish the objects; and
with the control and evaluation unit being configured to associate a risk classification with each object at least in dependence on the position of the object with respect to another object.
